(19) United States
(12) Patent Application Publication
(10) Pub. No.: US 2011/0316296 A1
(43) Pub. Date: Dec. 29, 2011

(54) DOG LITTER GLOVES

(76) Inventors: JIM COLLINS, Waretown, NJ (US); Dan Collins, Waretown, NJ (US)

(21) Appl. No.: 12/822,159

(22) Filed: Jun. 23, 2010

(51) Int. Cl. A01K 29/00

(52) U.S. Cl. 294/1.3

(57) ABSTRACT

A dog litter glove or mitten for collecting dog litter comprising: a hand section; a closure mechanism at an open end of the glove; and an elongated midsection, where said midsection extends down from the hand section and abuts a cuff section, where said cuff section includes a width greater than the width of the midsection. The closure mechanism may include at least one of a zip lock seal and a twist tie. The cuff of the dog litter glove may be rolled up to turn the glove inside out to create a sealed flexible container for the dog litter disposable.

### BACKGROUND OF THE INVENTION

1. Field of Invention

The present invention relates to gloves that are utilized to handle dog litter for disposal.

2. Description of Related Art

Dogs are a common household pet of many individuals. Dog owners must care for all of the needs associated with their dog that includes feeding, cleaning, veterinarian needs and disposal of litter. Some dogs are confined to open areas or yards near their owner's home or property and therefore utilize that area to relieve themselves of dog litter on a daily basis. Other dogs may reside within an apartment or small indoor living space and therefore these dogs need to be walked outdoors to dispose of their litter. The dog owner must handle and dispose of the dog litter in such situations because law or regulations that govern the area usually require removal. Some dog owners ignore these requirements and leave dog litter in public areas, thus creating a continuing problem in many urban and suburban areas.

Various devices have been developed to handle dog litter. Many of these devices involving shovels, rakes and kits that helps the dog owner to select and dispose of dog litter. Many times the owner must utilize their hands in addition to any tools or utensils in disposal of dog litter. One common device used by dog owners is a scooper that is used to scoop up the dog litter and dispose of the litter in a trash or other waste container.

One draw back to using utensils such as a scooper or shovel to collect dog litter is that the utensils must be cleaned on a regular basis to remove any dog litter residue that remains after use thereof. Further, such devices may have a limited shelf life and may be prone to damage or deterioration over a period of time.

In order to address the collection of dog litter it would be advantageous to have a device that is easy to use, disposable and could assist in handling and containment of the dog litter for disposal.

### SUMMARY OF THE INVENTION

The present invention relates to a dog litter glove or mitten for collecting dog litter comprising: a hand section; a closure means at an open end of the glove; and an elongated midsection, where said midsection extends down from the hand section and abuts a cuff section, where said cuff section includes a width greater than the width of the midsection. The closure means may include at least one of a zip lock seal and a twist tie. The cuff of the dog litter glove may be rolled up to turn the glove inside out to create a sealed flexible container for the dog litter disposable.

### BRIEF DESCRIPTION OF DRAWINGS

FIG. 1 depicts a first exemplary embodiment of a dog litter glove according to the present invention.

FIG. 2 depicts a second exemplary embodiment of a dog litter glove according to the present invention.

### DETAILED DESCRIPTION

The present invention relates to a glove that may be utilized by a dog owner to collect and dispose of dog litter. The glove according to the present invention provides a single device to handle and contain dog litter for disposal.

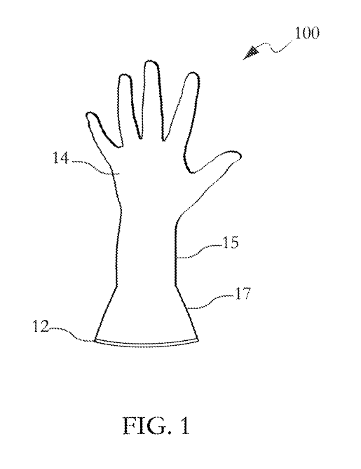

A Dog Litter Glove 100 according to the present invention is depicted in FIG. 1. The dog litter glove 100 is made of flexible biodegradable material that includes an opening for insertion of a user's hand. The litter glove 100 according to the present invention shows a hand section 14 and a closure means 12 at open end of the glove. The glove 100 includes an elongated midsection 15 that extends down from the hand section 14 and abuts a cuff section 17.

The cuff section 17 has a width that is greater than the midsection 15 of the litter glove 100. A user inserts the glove 100 over his or her hand to handle and pick up the dog litter while their hand is covered with the glove 100. Once the dog litter is within the grasp of the user the cuff section 17 of the glove 100 is rolled inward to create an enclosure for the dog litter. Consequently the glove is turned inside out as the user removes their hand from the glove 100 and the dog litter is contained within the glove 100. The closure means 12 is used to seal the glove and provide an enclosed container for the disposal of the dog litter. The closure means 12 may include a zip lock type containment means or alternatively a twist tie that may be used to close the opening of the glove for the disposal of the dog litter.

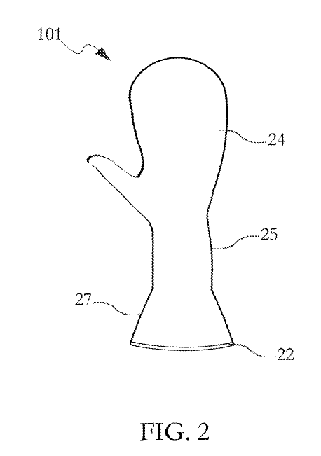

FIG. 2 entails an alternative embodiment of the present invention where a litter mitten 101 is depicted. The Litter Mitten 101 includes a mitten 24 that is includes an extended midsection 25 and a cuff section 27. The cuff section 27 has a width greater than the midsection 25. A closure means 22 is provided at the end of the cuff section 27. The Mitten 101 functions similar to the Litter Glove 100. The litter is collected while the Mitten 101 is over the user's hand and the cuff section 17 is rolled up inside out and sealed with the closure means 22. The Mitten 101 or the Glove 100 according to the present invention both provide a means for the collection of dog litter which first protects the user's hands and provides a convenient means to contain the dog litter for disposal. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dog litter glove for collecting dog litter comprising:
a hand section;
a closure means at an open end of the glove; and
an elongated midsection, where said midsection extends down from the hand section and abuts a cuff section, where said cuff section includes a width greater than the width of the midsection.

2. The dog litter glove according to claim 1, where said closure means includes at least one of a zip lock seal and a twist tie.

3. The dog litter glove according to claim 1, where the cuff may be rolled up to turn the glove inside out.

4. A dog litter mitten for collecting dog litter comprising:
a hand section;
a closure means at an open end of the glove; and
an elongated midsection, where said midsection extends down from the hand section and abuts a cuff section, where said cuff section includes a width greater than the width of the midsection.

5. The dog litter mitten according to claim 4, where said closure means includes at least one of a zip lock seal and a twist tie.

6. The dog litter glove according to claim 5, where the cuff may be rolled up to turn the glove inside out.

7. A method of dog litter collection comprising the steps of:
a. inserting a user's hand into a flexible glove;
b. collecting dog litter by manually grasping the dog litter;
c. removing the glove from the user's hand;
d. rolling the glove inside out while performing the step of removing the glove;
e. releasing the dog litter into the glove as the glove is removed from the user's hand; and
f. sealing the glove with a closure means after the glove is removed from the user's hand.

8. The method according to claim 7, where the closure means includes at least one of a zip lock seal and a twist tie.

9. The method according to claim 8, further including the step of: sealing the glove with the zip lock seal.

10. The method according to claim 8, further including the step of: sealing the glove with the twist tie.
